(19) United States
(12) Patent Application Publication
(10) Pub. No.: US 2012/0236407 A1
(43) Pub. Date: Sep. 20, 2012

(54) SUPPORT DEVICE FOR THREE-DIMENSIONAL GLASSES

(75) Inventors: Eui Shik YOON, Suwon-si (KR); Se Ki JANG, Hwaseong-si (KR)

(73) Assignee: SAMSUNG ELECTRONICS CO., LTD., Suwon-si (KR)

(21) Appl. No.: 13/422,572

(22) Filed: Mar. 16, 2012

(30) Foreign Application Priority Data
Mar. 16, 2011 (KR) 10-2011-0023403

(51) Int. Cl. G02B 27/22; G09F 15/02; G02B 7/00

(52) U.S. Cl. 359/464; 248/124.1; 40/584

(57) ABSTRACT

A support device for three-dimensional glasses includes a stand extending upward and a cradle mounted on the stand to support three-dimensional glasses. The cradle is movable in an up and down direction and rotatable in a left-right direction or an up-down direction. Therefore, a user may easily adjust a position of the cradle and conveniently use three-dimensional glasses.

### CROSS-REFERENCE TO RELATED APPLICATION

This application claims the benefit of Korean Patent Application No. 2011-0023403, filed on Mar. 16, 2011 in the Korean Intellectual Property Office, the disclosure of which is incorporated herein by reference.

### BACKGROUND

1. Field

Exemplary embodiments relate to a support device on which three-dimensional (3D) glasses used to see a 3D image displayed on a 3D image display apparatus are placed.

2. Description of the Related Art

Generally, a 3D image display apparatus alternately displays an image for a left eye and an image for a right eye so that a 3D effect is created by separately showing different images to both eyes.

In order to obtain the 3D effect, 3D glasses corresponding to a 3D image display apparatus are required. One type of 3D glasses is polarized 3D glasses with two polarizing lenses having a polarization angle difference of 90 degrees. The other type of 3D glasses is shutter glass type 3D glasses with liquid crystal shutters as lenses, in which different images for left and right eyes are separately shown to left and right eyes through a liquid crystal shutter for a left eye and a liquid crystal shutter for a right eye.

### SUMMARY

An aspect of the exemplary embodiments is to provide a support device for three-dimensional glasses, which enables a user to more conveniently use three-dimensional glasses.

Additional aspects of exemplary embodiments will be set forth in part in the description which follows and, in part, will be obvious from the description, or may be learned by practicing exemplary embodiments.

In accordance with one aspect of exemplary embodiments a support device for three-dimensional glasses includes a stand extending upward, and a cradle mounted on the stand to support three-dimensional glasses thereon. The cradle is capable of moving up and down and rotating in a left-right direction or up-down direction.

The support device for three-dimensional glasses may further include a base coupled to a bottom of the stand to stably support the stand on a floor.

The support device for three-dimensional glasses may further include a lifting device to move the cradle in an up-down direction.

The lifting device may include a lifting member mounted in the stand, the lifting member supporting the cradle thereon and being capable of moving up and down through the stand, a rail member mounted in the stand, the rail member having a slot extending in an up-down direction, and a lifting guide to connect the lifting member to the rail member, the lifting guide being capable of moving along the rail member.

The lifting device may further include an upper pulley disposed at an upper portion of the rail member, a lower pulley disposed at a lower portion of the rail member, a wire wound on the upper pulley and the lower pulley and connected with the lifting guide, and a friction pulley around which the wire is wound through at least one turn to create frictional force between the frictional pulley and the wire.

The lifting guide may include a lifting member fixing part to which a lower end of the lifting member is fixed, a wire fixing part to which the wire is fixed, and a sliding part having a portion slidably received in the slot of the rail member.

The lifting device may further include a moving member mounted to a lower portion of the rail member and to which the lower pulley is rotatably mounted, the moving member being capable of moving up and down, and an elastic member having a first end supported by a lower end of the rail member and a second end supported by the moving member, thereby elastically biasing the moving member downward.

The friction pulley may be fixed so as to be incapable of rotating.

The cradle may include a pair of support frames, each of which has a first end and a second end, a pair of mounting members, each of which is coupled to the first end of each of the pair of support frames to support each temple of three-dimensional glasses thereon, and a connecting member to connect the second end of each of the pair of support frames to each other.

The support device for three-dimensional glasses may further include a rotating device to achieve rotation of the cradle in a left-right direction or up-down direction.

The rotating device may include a first hinge member mounted to an upper end of the lifting member, the first hinge member being capable of rotating in a left-right direction, and a second hinge member mounted to the first hinge member and to which the cradle is mounted, the second hinge member being capable of rotating in an up-down direction.

The rotating device may further include a rotating guide mounted to an upper end of the lifting member, a first coupling member having an upper end caught by the first hinge member and a lower end extending through the first hinge member and the rotating guide, and a second coupling member coupled to the lower end of the first coupling member and caught by the rotating guide.

The first hinge member may have a pair of hinge protrusions extending sideways opposite to each other, and the second hinge member may consist of a pair of pieces, each of which being formed with a hinge hole through which each of the pair of hinge protrusions of the first hinge member is inserted.

As described above, the cradle may move up and down and also may rotate in an up-down direction or left-right direction, thereby enabling a user to easily adjust a position of the cradle and conveniently use three-dimensional glasses.

In accordance with one aspect of exemplary embodiments a support device for three-dimensional glasses includes a stand, a cradle disposed on the stand, and a three-dimensional glasses (3D) interface disposed on the cradle which receives and supports (3D) glasses.

### BRIEF DESCRIPTION OF THE DRAWINGS

These and/or other aspects of exemplary embodiments will become apparent and more readily appreciated from the following description of the exemplary embodiments, taken in conjunction with the accompanying drawings of which:

FIG. 1 is a perspective view showing a three-dimensional image display apparatus and a support device for three-dimensional glasses according to an exemplary embodiment;

FIG. 2 is a perspective view showing the support device for three-dimensional glasses according to an aspect of an exemplary embodiment;

FIG. 3 is an exploded perspective view showing a stand of the support device for three-dimensional glasses according to an aspect of an exemplary embodiment;

FIG. 4 is an exploded perspective view showing a cradle of the support device for three-dimensional glasses according to an aspect of an exemplary embodiment;

FIG. 5 is a perspective view showing a lifting device of the support device for three-dimensional glasses according to an aspect of an exemplary embodiment;

FIG. 6 is an exploded perspective view showing an upper pulley assembly and a friction pulley assembly of the support device for three-dimensional glasses according to an aspect of an exemplary embodiment;

FIG. 7 is an exploded perspective view showing a lower pulley assembly and a lifting guide of the support device for three-dimensional glasses according to an aspect of an exemplary embodiment;

FIG. 8 is a side view showing operation of the lifting device of the support device for three-dimensional glasses according to an aspect of an exemplary embodiment;

FIG. 9 is an exploded perspective view showing a rotating device of the support device for three-dimensional glasses according to an aspect of an exemplary embodiment;

FIG. 10 is a sectional view showing the rotating device of the support device for three-dimensional glasses according to an aspect of an exemplary embodiment;

FIG. 11 is a perspective view showing the cradle rotating in a left-right direction by the rotating device in the support device for three-dimensional glasses according to an aspect of an exemplary embodiment; and

FIG. 12 is a side view showing the cradle rotating in an up-down direction by the rotating device in the support device for three-dimensional glasses according to an aspect of an exemplary embodiment.

### DETAILED DESCRIPTION

Reference will now be made in detail to the exemplary embodiments which are illustrated in the accompanying drawings, wherein like reference numerals refer to like elements throughout.

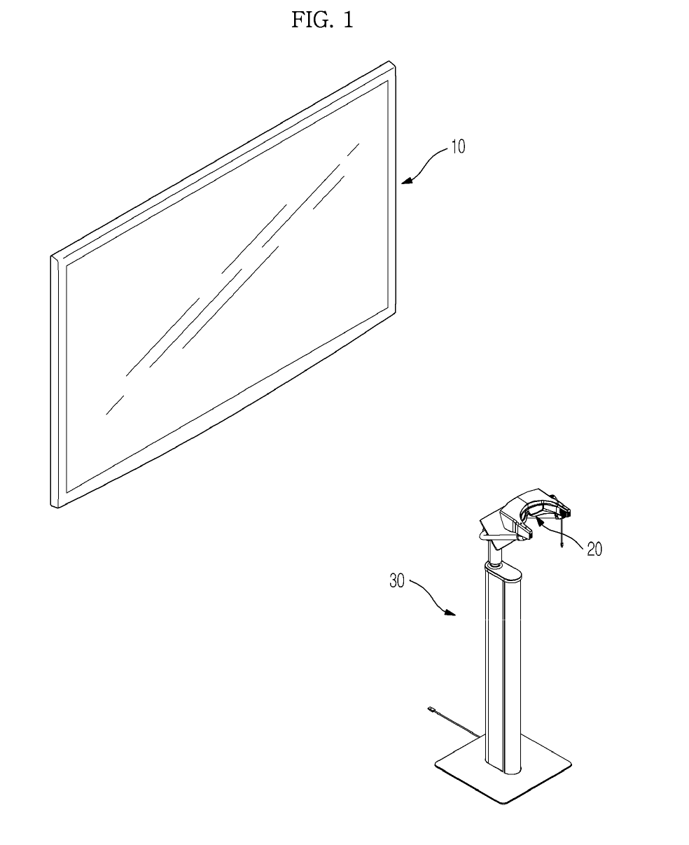

Referring to FIG. 1, a support device 30 for three-dimensional (3D) glasses according to an exemplary embodiment is configured to place 3D glasses 20 thereon and located in front of a 3D image display apparatus 10 so that a user may conveniently see a 3D image displayed on the 3D image display apparatus 10 with the 3D glasses 20.

In this exemplary embodiment, the 3D glasses 20 placed on the support device 30 are polarized 3D glasses with polarizing filters, however shutter glass type 3D glasses with liquid crystal shutters may also be placed on the support device 30.

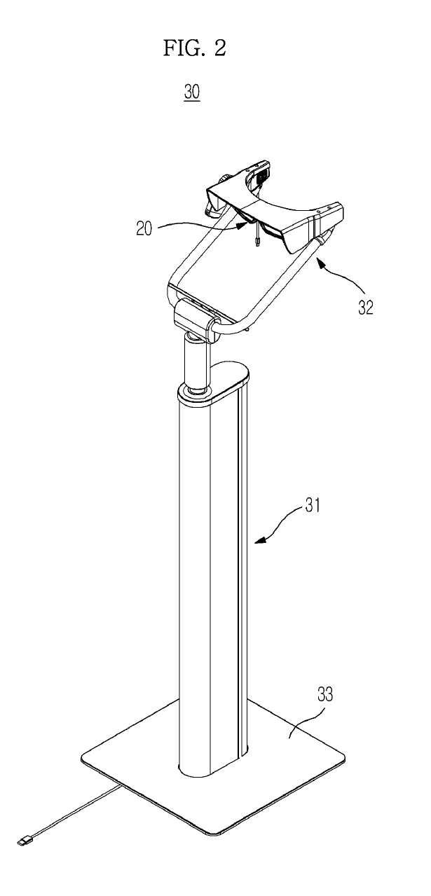

As shown in FIG. 2, the support device 30 for 3D glasses includes a stand 31 extending upward, and a cradle 32 mounted to a top of the stand 31. The 3D glasses 20 are put on the cradle 32. The support device 30 further includes a base 33 coupled to a bottom of the stand 31. The base 33 is placed on a floor and has a relatively large area compared with the stand 31 in order to prevent the stand 31 from falling over.

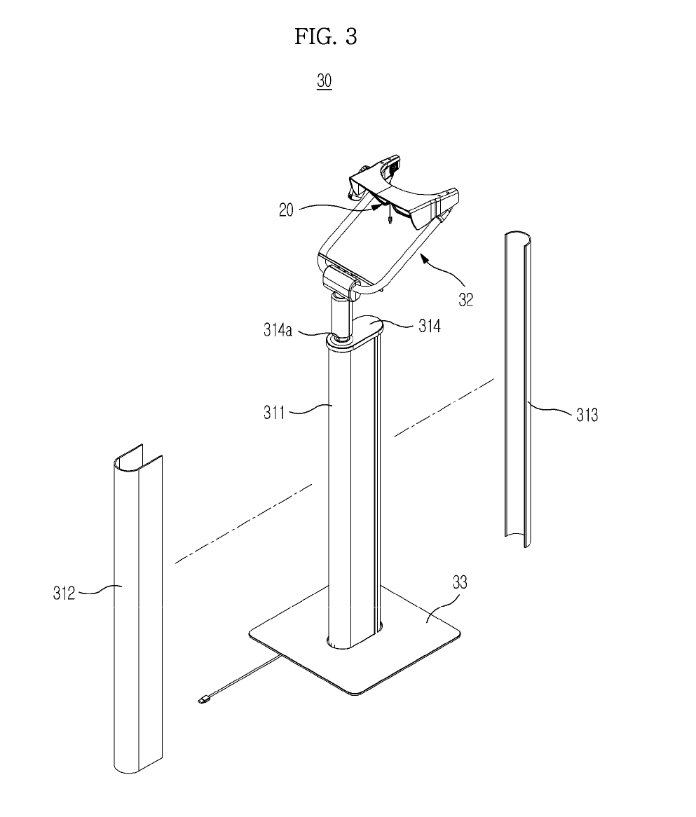

As shown in FIG. 3, the stand 31 includes outer cases 312 and 313 to form the external appearance of the stand 31, and an inner case 311 disposed in the outer cases 312 and 313. The outer cases 312 and 313 and the inner case 311 have a gap therebetween. The stand 31 further includes an upper case 314 coupled to tops of the outer cases 312 and 313 to cover the same. The upper case 314 is formed with a hole 314a through which a lifting member 341 (which will be described later) is mounted. The inner case 311 is shaped as a pipe having an approximately elliptical cross-section. The two outer cases 312 and 313 are separable and coupled to both sides of the inner case 311, respectively. Accordingly, an advertisement may be posted in the gap between the inner case 311 and the outer cases 312 and 313 and may be replaced by detaching the outer cases 312 and 313 from the inner case 311.

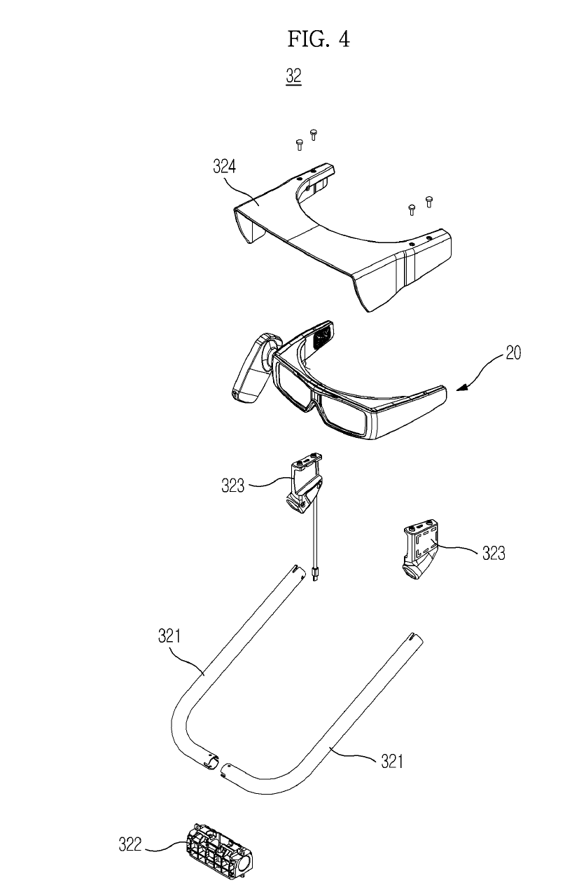

The cradle 32, as shown in FIG. 4, includes a pair of support frames 321, each having an L shape, a connecting member 322 to connect the pair of support frames 321 to each other in a U shape, a pair of mounting members 323 respectively coupled to end portions of the pair of support frames 321 so that temples of the 3D glasses 20 are respectively mounted thereto, and a cover 324 mounted to the mounting members 323 to cover the 3D glasses 20.

The support device 30 for 3D glasses is configured to adjust a height or an angle of the cradle 32 so that a user may conveniently use the 3D glasses 20 supported by the cradle 32.

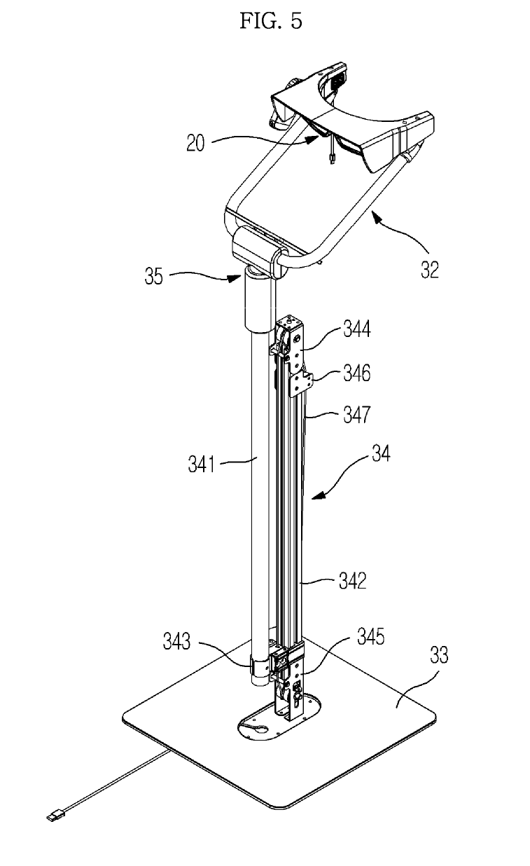

In order to adjust a height or an angle of the cradle 32, as shown in FIG. 5, the support device 30 further includes a lifting device 34 to achieve up-down movement of the cradle 32, and a rotating device 35 to achieve rotation of the cradle 32 in a left-right direction or an up-down direction. The cradle 32 is mounted to the stand 31 by the lifting device 34 and the rotating device 35.

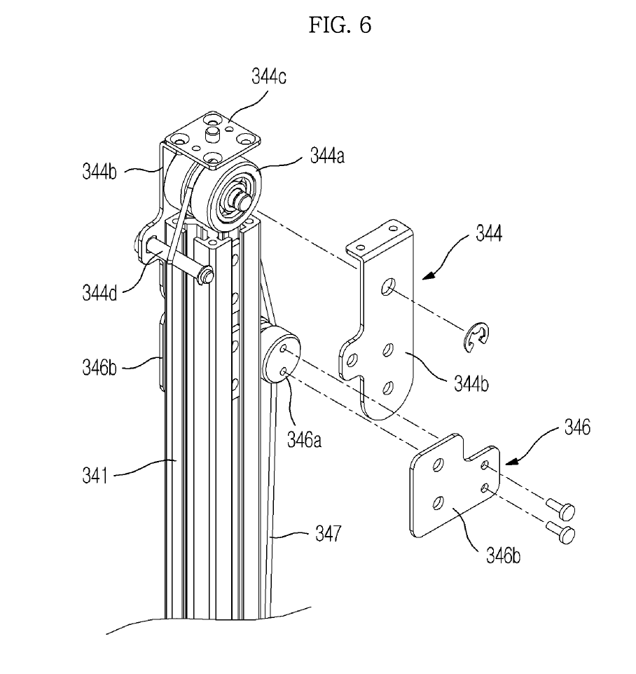

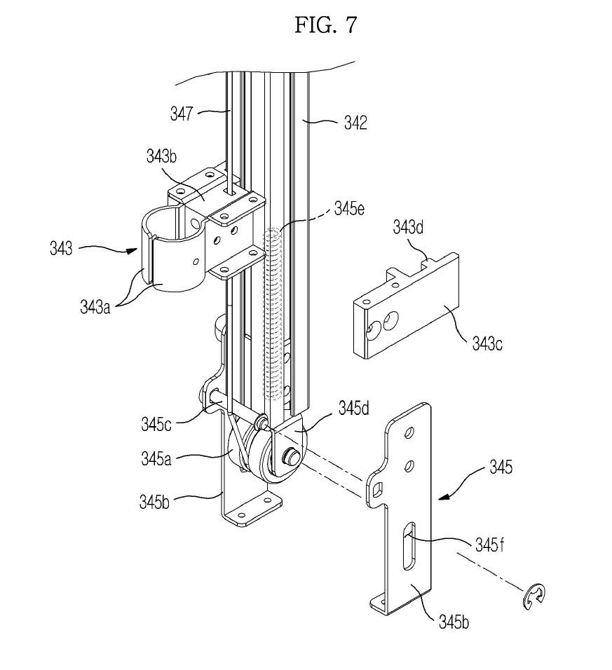

The lifting device 34 is mounted in the stand 31. As shown in FIG. 5 through FIG. 7, the lifting device 34 includes a lifting member 341 having a rod shape and capable of moving up and down, a rail member 342 extending upward along the stand 31 to guide movement of the lifting member 341 in an up-down direction, and a lifting guide 343 to connect the lifting member 341 to the rail member 342. The rail member 342 has slots formed on both sides in a longitudinal direction of the rail member 342. The cradle 32 is disposed on the lifting member 341 of the lifting device 34.

The lifting device 34 is also configured to keep the lifting member 341 at a certain position after the lifting member 341 moves up or down to the position along the rail member 342. To this end, the lifting device 34 further includes an upper pulley assembly 344 mounted to an upper end of the rail member 342 and having a rotatable upper pulley 344a, a lower pulley assembly 345 mounted to a lower end of the rail member 342 and having a rotatable lower pulley 345a, a wire 347 wound on the upper pulley 344a and the lower pulley 345a, and a friction pulley assembly 346 having a friction pulley 346a. The wire 347 is connected with the lifting guide 343, and accordingly runs on the upper pulley 344a and the lower pulley 345a through interlocking with up-down movement of the lifting member 341. The wire 347 is wound around the friction pulley 346a through a turn (about 360 degrees) to create friction with the friction pulley 346a. However, the wire 347 may be wound around the friction pulley 346a through one or more turns.

The upper pulley assembly 344 includes a pair of upper pulley brackets 344b having a plate shape and coupled to both sides of an upper end of the rail member 342, a connecting bracket 344c to connect upper ends of the pair of upper pulley brackets 344b to each other, and an upper support shaft 344d to support an inner side of the wire 347 so that the wire 347 is spaced from the rail member 342. The upper pulley 344a is disposed in a space defined by the upper pulley brackets 344b and the connecting bracket 344c, and is rotatably mounted to the upper pulley brackets 344b.

The friction pulley assembly 346 includes a pair of friction pulley brackets 346b having a plate shape and coupled to both sides of an upper portion of the rail member 342. The friction pulley assembly 346 is located below the upper pulley assembly 344. The friction pulley 346a is mounted between the pair of friction pulley brackets 346b. In order to create frictional force between the friction pulley 346a and the wire 347, the friction pulley 346a is fixed to the friction pulley brackets 346b. Accordingly, although the wire 347 runs along an outer circumferential surface of the friction pulley 346a, the friction pulley 346a does not rotate.

The lower pulley assembly 345 includes a pair of lower pulley brackets 345b having a plate shape and coupled to both sides of a lower end of the rail member 342, and a lower support shaft 345c to support the inner side of the wire 347 so that the wire 347 is spaced from the rail member 342. The lower pulley 345a is rotatably mounted between the lower pulley brackets 345b.

The lifting guide 343 includes a pair of lifting member fixing parts 343a, each having a semi-circular end portion to which a lower end of the lifting member 341 is fixed, a wire fixing part 343b disposed between the pair of lifting member fixing parts 343a, to which the wire 347 is fixed, and a pair of sliding parts 343c, each having a sliding protrusion 343d slidably received in each of the slots of the rail member 342.

In order to maintain constant frictional force between the wire 347 and the friction pulley 346a, tension of the wire 347 should be kept constant. To this end, the lifting device 34 further includes a moving member 345d mounted to a lower portion of the rail member 342 and capable of moving up and down, and an elastic member 345e having an upper end supported by the rail member 342 and a lower end supported by the moving member 345d, thereby elastically biasing the moving member 345d downward. The lower pulley 345a is rotatably mounted to the moving member 345d. Each of the lower pulley brackets 345b is formed with a slit 345f extending in an up-down direction. The slit 345f receives a shaft of the lower pulley 345a so that the shaft of the lower pulley 345a may move up and down along the slit 345f. Since the lower pulley 345a and the moving member 345d are elastically biased downward by an elastic restoring force of the elastic member 345e, the tension of the wire 347 is kept constant.

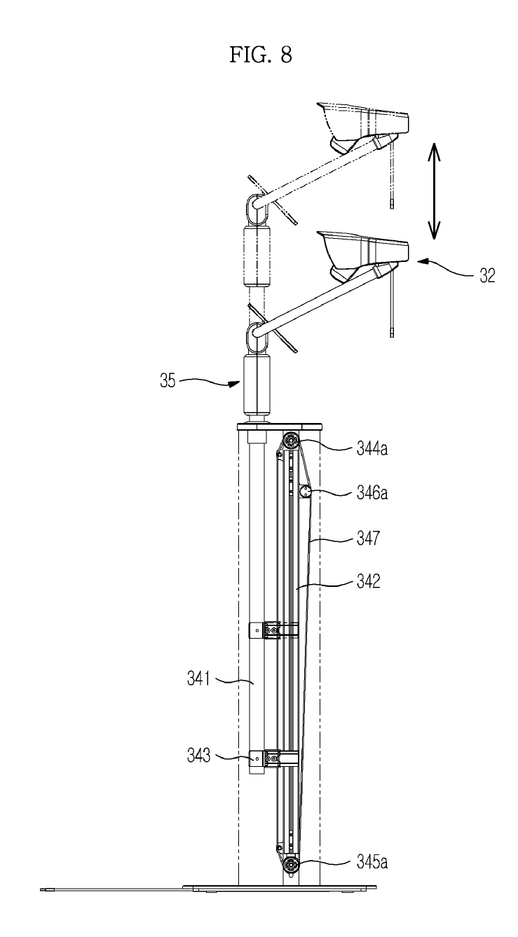

If a user applies force to the cradle 32 to move the same up or down, as shown in FIG. 8, the lifting member 341 moves up or down with the lifting guide 343 along the rail member 342. If the user no longer applies force to the cradle 32 when the cradle 32 reaches a certain position, the lifting guide 343, the lifting member 341 and the cradle 32 are kept at the position by the frictional force between the wire 347 and the friction pulley 346a.

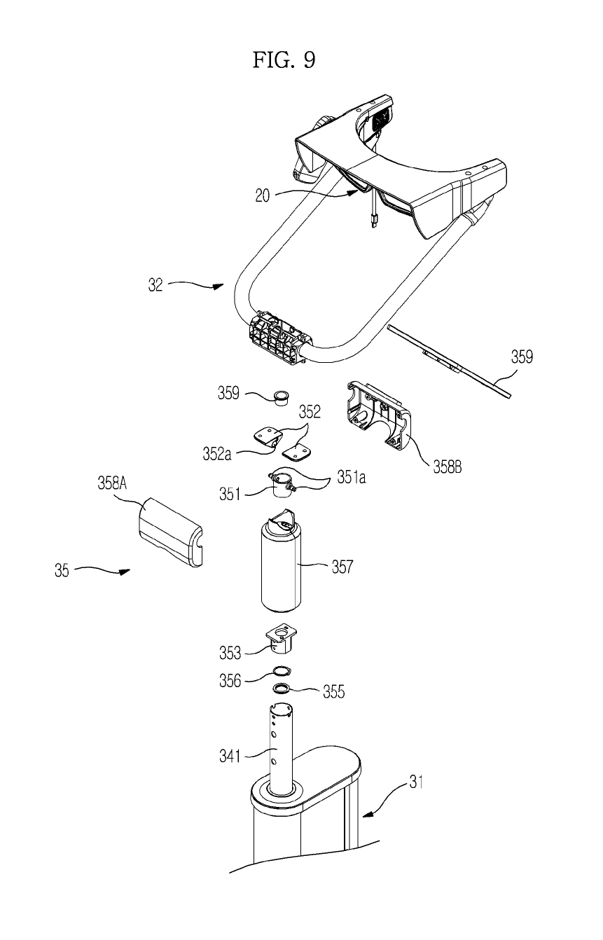

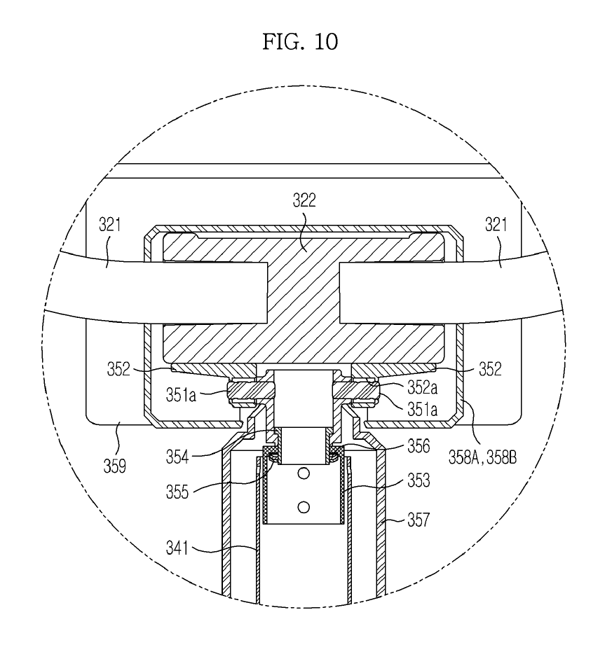

As shown in FIG. 9 and FIG. 10, the rotating device 35 includes a first hinge member 351 mounted to an upper end of the lifting member 341 and capable of rotating in a left-right direction, and a second hinge member 352 mounted to the first hinge member 351 and capable of rotating in an up-down direction. Accordingly, the cradle 32 may rotate in the left-right direction by the first hinge member 351, and may also rotate in the up-down direction by the second hinge member 352.

The rotating device 35 further includes a rotating guide 353 fixed to an upper end of the lifting member 341, and a pair of coupling members 354 and 355 coupled to the rotating guide 353 and the first hinge member 351. The coupling members 354 and 355 include a first coupling member 354 having an upper end caught by the first hinge member 351 and a lower end extending through the first hinge member 351 and the rotating guide 353, and a second coupling member 355 coupled to the lower end of the first coupling member 354 and caught by the rotating guide 353. The rotating device 35 further includes a washer 356 provided between the second coupling member 355 and the rotating guide 353 so that the first hinge member 351 may easily rotate in the left-right direction with respect to the rotating guide 353 fixed to the lifting member 341.

The first hinge member 351 is provided with hinge protrusions 351a extending sideways opposite to each other from an upper portion of the first hinge member 351. The second hinge member 352 consists of two pieces. Each piece of the second hinge member 352 is formed with a hinge hole 352a through which each of the hinge protrusions 351 a of the first hinge member 351 is inserted. Accordingly, the second hinge member 352 may rotate in the up-down direction on the hinge protrusions 351 a of the first hinge member 351. The second hinge member 352 is mounted to a bottom of the connecting member 322. As a result, the cradle 32 may rotate in the up-down direction by the second hinge member 352.

The rotating device 35 further includes a first hinge case 357 having a cylindrical shape and mounted to the upper end of the lifting member 341, and a pair of second hinge cases 358a and 358b coupled to each other, interposing the connecting member 322 and the second hinge member 352 therebetween. The first hinge case 357 covers the upper end portion of the lifting member 341 and front and rear surfaces of the first hinge member 351. One of the second hinge cases 358a and 358b is disposed on a front surface of the connecting member 322 and the other of the second hinge cases 358a and 358b is disposed on a rear surface of the connecting member 322, so that the second hinge cases 358a and 358b cover the connecting member 322 and the second hinge member 352. The second hinge cases 358a and 358b are mounted with an advertising board 359 to which an advertisement may be attached.

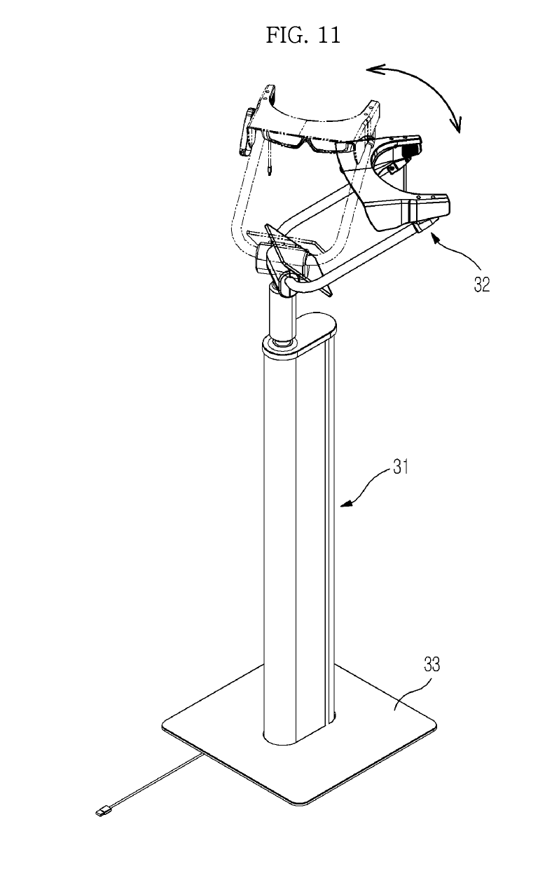

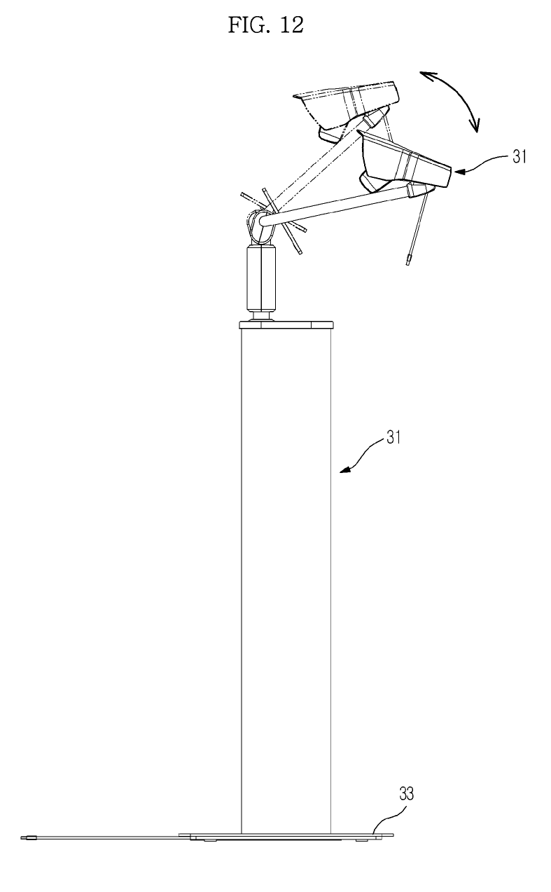

Accordingly, as shown in FIG. 11, the cradle 32 may rotate about the axis of the first hinge member 351 in the left-right direction. Also, as shown in FIG. 12, the cradle 32 may rotate about the axis of the second hinge member 352 in the up-down direction.

As is apparent from the above description, the cradle 32 may move up and down by the lifting device 34, and also may rotate in the up-down or left-right direction by the rotating device 35. Therefore, a user may easily adjust a height and an angle of the cradle 32.

Although a few exemplary embodiments have been shown and described, it would be appreciated by those skilled in the art that changes may be made in these exemplary embodiments without departing from the principles and spirit of the inventive concept, the scope of which is defined in the claims and their equivalents.

What is claimed is:

1. A support device for three-dimensional glasses comprising:
a stand extending upward; and
a cradle mounted on the stand which supports three-dimensional glasses thereon,
wherein the cradle is movable in an up and down direction and rotatable in a left-right direction or an up-down direction.

2. The support device for three-dimensional glasses according to claim 1, further comprising:
a base coupled to a bottom of the stand which supports the stand.

3. The support device for three-dimensional glasses according to claim 1, further comprising:
a lifting device which moves the cradle in an up-down direction.

4. The support device for three-dimensional glasses according to claim 3, wherein the lifting device comprises:
a lifting member mounted in the stand, wherein the lifting member supports the cradle and is movable in an up and down direction through the stand;
a rail member mounted in the stand, wherein the rail member comprises a slot extending in an up-down direction; and
a lifting guide which connects the lifting member to the rail member, wherein the lifting guide is movable along the rail member.

5. The support device for three-dimensional glasses according to claim 4, wherein the lifting device further comprises:
an upper pulley disposed at an upper portion of the rail member;
a rotatable lower pulley disposed at a lower portion of the rail member;
a wire wound on the upper pulley and the lower pulley and connected with the lifting guide; and
a friction pulley around which the wire is wound through at least one turn to create frictional force between the frictional pulley and the wire.

6. The support device for three-dimensional glasses according to claim 5, wherein the lifting guide comprises:
a lifting member fixing part to which a lower end of the lifting member is fixed;
a wire fixing part to which the wire is fixed; and
a sliding part having a portion slidably received in the slot of the rail member.

7. The support device for three-dimensional glasses according to claim 5, wherein the lifting device further comprises:
a moving member mounted to a lower portion of the rail member and to which the lower pulley is rotatably mounted, wherein the moving member is movable in an up and down direction; and
an elastic member comprising a first end supported by a lower end of the rail member and a second end supported by the moving member, thereby elastically biasing the moving member downward.

8. The support device for three-dimensional glasses according to claim 5, wherein the friction pulley is fixed so as to be incapable of rotating.

9. The support device for three-dimensional glasses according to claim 1, wherein the cradle comprises:
a pair of support frames, each comprising a first end and a second end;
a pair of mounting members, each of which is coupled to the first end of each of the pair of support frames to support each temple of three-dimensional glasses thereon; and
a connecting member which connects the second end of each of the pair of support frames to each other.

10. The support device for three-dimensional glasses according to claim 4, further comprising:
a rotating device which rotates the cradle in a left-right direction or an up-down direction.

11. The support device for three-dimensional glasses according to claim 10, wherein the rotating device comprises:
a first hinge member mounted to an upper end of the lifting member, wherein the first hinge member is rotatable in a left-right direction; and
a second hinge member mounted to the first hinge member and the cradle, wherein the second hinge member is rotatable in an up-down direction.

12. The support device for three-dimensional glasses according to claim 11, wherein the rotating device further comprises:
a rotating guide mounted to an upper end of the lifting member,
a first coupling member having an upper end caught by the first hinge member and a lower end extending through the first hinge member and the rotating guide; and
a second coupling member coupled to the lower end of the first coupling member and caught by the rotating guide.

13. The support device for three-dimensional glasses according to claim 11, wherein the first hinge member comprises a pair of hinge protrusions extending sideways opposite to each other, and
wherein the second hinge member comprises a pair of pieces, each of which comprises a hinge hole through which each of the pair of hinge protrusions of the first hinge member is inserted.

14. The support device for three-dimensional glasses according to claim 13, further comprising:
a first hinge case mounted to the upper end of the lifting member; and
a pair of second hinge cases coupled to each other which interpose a connecting member and the second hinge member.

15. The support device for three-dimensional glasses according to claim 14, further comprising:
an advertising board mounted to the pair of second hinge cases.

16. A support device for three-dimensional glasses comprising:
a stand;
a cradle disposed on the stand; and
a three-dimensional (3D) glasses interface disposed on the cradle which receives and supports 3D glasses.

17. The support device for three-dimensional glasses according to claim 16, further comprising:
3D glasses coupled to the 3D glasses interface;

18. The support device for three-dimensional glasses according to claim 17, further comprising:
a lifting device which moves the cradle in an up-down direction.

19. The support device for three-dimensional glasses according to claim 18, further comprising:
a rotating device which rotates the cradle in a left-right direction or an up-down direction.
